(19) United States
(12) Patent Application Publication
(10) Pub. No.: US 2017/0018030 A1
(43) Pub. Date: Jan. 19, 2017

(54) System and Method for Determining Credit Worthiness of a User

(71) Applicant: MB Technology Partners Ltd., Singapore (SG)

(72) Inventors: Charles Hugues Max Crouspeyre, Singapore (SG); Pietro Ventani, Singapore (SG); Jeroen Eric van Overbeek, Bali (ID)

(21) Appl. No.: 15/195,190

(22) Filed: Jun. 28, 2016

Related U.S. Application Data
(60) Provisional application No. 62/193,766, filed on Jul. 17, 2015.

(51) Int. Cl. G06Q 40/02; G06N 99/00; G06Q 50/00

(52) U.S. Cl. CPC G06Q 40/025; G06Q 50/01; G06N 99/005

(57) ABSTRACT

Disclosed is a method and system for determining credit worthiness of a user on an online platform. The system may comprise a user device further comprising a memory coupled with a processor. The method may comprise analysing the captured personal data, social networking data, the psychometric data and the user's mobile phone metadata and his geolocation data in order to determine user's personal attributes, socio-behaviour attributes, psychometric attributes and socio-economic attributes. The method may further comprise comparing the user-specific print with a plurality of predefined patterns pre-trained by a machine learning model in order to match the user's-specific pattern with at least one of the plurality of predefined patterns. The method may further comprise computing a score for the user based upon the matching of the user-specific print with at least one of the plurality of predefined patterns, wherein the score is indicative of a credit worthiness of the user.

### CROSS-REFERENCE TO RELATED APPLICATIONS AND PRIORITY

The present application claims priority from U.S. Provisional Patent Application. No. 62/193,766 dated 17 Jul. 2015.

### TECHNICAL FIELD

The present disclosure in general relates to the field of data analytics. More particularly, the present disclosure relates to a system and method for determining credit worthiness of a user on an online platform.

### BACKGROUND

Small and Micro enterprises contribute a major component of the economic growth across the world. These enterprises employ very large segments of the active population throughout the world. In majority of the cases, such enterprises are run by entrepreneurs/individuals typically working with family members and are often located in the less affluent segments of society. Though majority of these enterprises have a potential to grow into large organizations, however the lack of financial support from recognized funding sources such as banks and financial institutions is the biggest barrier in their growth. The primary reasons why bank and financial institutions do not consider these small and micro enterprises to provide financial support is that these enterprises are not incorporated and have no credit record or meaningful assets. As a consequence, these enterprises are unable to access credit through conventional banking channels as these channels need financial history, accurate personal data and a credit history of a borrower, enabling assessment of the credit risk. The entrepreneurs running such enterprises end up accessing credit through alternative channels and from illegal syndicates which provide financial support at exorbitant rate of interest.

Many of these enterprises are unable to payback their loan amount on time due to heavy interest rates and end up in shutting down their business. Hence there is a need for a system and method for ascertaining a credit worthiness of a potential borrower in order to provide financial support for his/her business growth.

### SUMMARY

This summary is provided to introduce concepts related to systems and methods for determining credit worthiness of a user and the concepts are further described below in the detailed description. This summary is not intended to identify essential features of the claimed subject matter nor is it intended for use in determining or limiting the scope of the claimed subject matter.

In one implementation, a method for determining a credit worthiness of a user is disclosed. The method may comprise capturing, by a processor, personal data, social networking data, psychometric data, metadata and geolocation data. In an embodiment, the social networking data is associated to a plurality of interactions of the user on one or more social networking platforms. Further, the psychometric data is associated to user's actions on a computer-based system. The examples of the user's actions may comprise the user's input data, user's way of providing the input data, user's sign-up process, user's approach for a loan request, and the like. The method may further comprise analysing, by the processor, the personal data, the social networking data, the psychometric data and the geolocation data in order to determine user's personal attributes, socio-behaviour attributes, psychometric attributes and socio-economic attributes. The method may further comprise generating, by the processor, a user-specific print based on a combination of the user's personal attributes, the socio-behaviour attributes, the psychometric attributes and the socio-economic attributes. The method may further comprise comparing, by the processor, the user-specific print with a plurality of predefined patterns pre-trained by a machine learning model in order to match the users-specific pattern with at least one of the plurality of predefined patterns. The method further comprise computing a score, by the processor, for the user based upon the matching of the user-specific pattern with the at least one of the plurality of predefined patterns, wherein the score is indicative of a credit worthiness of the user.

In another implementation, a system for determining a credit worthiness of a user is disclosed. The system may comprise a processor and a memory coupled with the processor, wherein the processor is capable of executing programmed instructions stored in the memory. The processor may execute a programmed instruction for capturing at least personal data, social networking data, psychometric data, metadata and geolocation data. In one embodiment, the social networking data is associated to a plurality of interactions of the user on one or more social networking platforms. Further, the psychometric data is associated to user's actions on one or more computer based systems. The examples of the user's actions may comprise user's input data, user's way of providing the input data, user's sign-up process, user's approach for a loan request, and the like. Further, the processor may execute a programmed instruction for analysing the personal data, the social networking data, the psychometric data and the user's computer-based system metadata and his geolocation data in order to determine user's personal attributes, socio-behaviour attributes, psychometric attributes and socio-economic attributes. The processor may further execute a programmed instruction for generating a user-specific print based on a combination of the user's personal attributes, the socio-behaviour attributes, the psychometric attributes and the socio-economic attributes. The processor may further execute a programmed instruction for comparing the user-specific print with a plurality of predefined patterns pre-trained on historical data by a machine learning model in order to match the user' s-specific pattern with at least one of the plurality of predefined patterns. The processor may further execute a programmed instruction for computing a score for the user based upon the matching of the user-specific pattern with at least one of the plurality of predefined patterns, wherein the score is indicative of a credit worthiness of the user.

In yet another implementation, a non-transitory computer readable medium storing program for determining a credit worthiness of a user is disclosed. The program may comprise an instruction for capturing at least personal data, social networking data, psychometric data, metadata and geolocation data. In one embodiment, the social networking data is associated to a plurality of interactions of the user on one or more social networking platforms. Further, the psychometric data is associated to user's actions on one or more computer based systems. Examples of the user's actions may comprise user's input data, user's way of providing the input data, user's sign-up process, user's approach for a loan request, and the like. Further, the program may comprise an instruction for analysing the personal data, the social networking data, the psychometric data and the user's mobile phone metadata and his geolocation data in order to determine user's personal attributes, socio-behaviour attributes, psychometric attributes and socio-economic attributes. The program may further comprise an instruction for generating a user-specific print based on a combination of the user's personal attributes, the socio-behaviour attributes, the psychometric attributes and the socio-economic attributes. The program may further comprise an instruction for comparing the user-specific print with a plurality of predefined patterns pre-trained by a machine learning model in order to match the user's-specific pattern with at least one of the plurality of predefined patterns. The program may further comprise an instruction for computing a score for the user based upon the matching of the user-specific print with at least one of the plurality of predefined patterns, wherein the score is indicative of a credit worthiness of the user.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for determining a credit worthiness of a user, in accordance with an embodiment of the present subject matter

FIG. 2 illustrates the system, in accordance with an embodiment of the present subject matter

FIG. 3 illustrates a method for determining credit worthiness of a user, in accordance with an embodiment of the present subject matter

### DETAILED DESCRIPTION

System(s) and method(s) for determining a credit worthiness of a user on an online platform is described. The system may compute a score (also referred hereinafter as a credit worthiness score interchangeably) for the user by processing user's personal attributes, socio-behaviour attributes, psychometric attributes and socio-economic attributes using a statistical model and thereby categorizing the user. This categorization may provide an eligibility of the user to receive a business loan. The system may enable the user to generate a user-specific print on an online platform in order to determine the credit worthiness of the user. The credit worthiness is determined based on a score computed based upon user's personal data, social networking data, psychometric data, metadata and geolocation data. In an aspect, the social networking data is associated to a plurality of interactions of the user on one or more social networking platforms. In another aspect, the psychometric data is associated to a user's actions on one or more computer based systems. The examples of the user's actions may comprise user's input data, user's way of providing the input data, user's sign-up process, user's approach for a loan request, and the like. The personal data may include personal information of the user comprising name, date of birth, primary address of residence, one or more secondary address of residence, educational qualification, professional history, place of business, business structure, size of business, hobbies, phone numbers. The plurality of interactions of the user on one or more social networking platforms may comprise comments, publications, interests of the user on one or more social networking platforms. The metadata may further comprise the user's computer-based system data including phone logs and the geolocation data. The geolocation data may provide primary significance for assuring whether the user lives at the place where he has provided the place of residence or the place of business. Further, the provision of the geolocation data associated to the user may further be used to quantify the level of confidence, the system may rely on the user by comparing the said geolocation data with geolocation information provided by the user in his/her social media content on the social media platforms. For example, the system may compare by verifying the posts on social media platforms associated with the geolocation data and thereby confirm his/her geolocation.

The system may analyse the user's personal data in order to determine a user personal attributes (or his/her personality print). Further, the system may analyse the social networking data of the user from one or more social networking platforms by performing Natural Language Processing, Text Mining and any other content analysis techniques in order to generate socio-behaviour attributes. The socio-behaviour attributes may provide information of the user's behaviour on online social networking sites including Facebook®, Twitter®, LinkedIn®, Instagram®, and the like and characteristics of the user personality and behaviour. The socio-behaviour attributes may further comprise one or more publications, likes, interactions made by the user on online databases to determine the user's interest and to analyze user's view towards the society. The system may compare the profile of the user on the social media platforms with one or more predefined profiles associated with the user for fraud detection purpose. The fraud detection herein refers to verify whether or not the user profile in the social media platforms is fake/fraud by comparing the user profile with the one or more predefined profiles associated with the user.

The system may further analyze the psychometric data associated to user's actions on a computer-based system. The psychometric behaviour attributes may be generated based on the user's actions including, but not limited to, input data provided by the user, user's way of providing the input data, user's sign-up process, user's approach for a loan request, and the like. The system may also correlate the user's metadata, within the platform, with the socio-economic data provided by the regional governmental organization or Non-governmental organization. The socio-economic data may be selected from that region where the user's place of business is located.

The system may further generate a user-specific print based on a combination of the user's personal attributes, the socio-behaviour attributes, the psychometric attributes and the socio-economic attributes. Further, the system may compare the user-specific print with a plurality of predefined patterns pre-trained by a machine learning model in order to match the user-specific print with at least one of the plurality of predefined patterns. The system may further compute a score for the user based upon the matching of the user-specific print with at least one of the plurality of predefined patterns, wherein the score is indicative of the credit worthiness of the user.

While aspects of described system and method determining credit worthiness of a user behaviour on an online platform may be implemented in any number of different computing systems, environments, and/or configurations, the embodiments are described in the context of the following exemplary system.

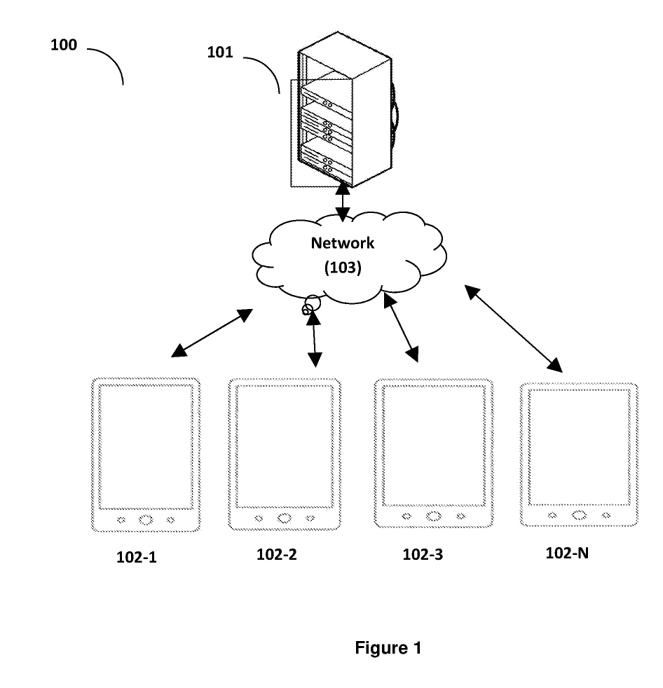

Referring now to FIG. 1, a network implementation 100 of a system 101 for determining credit worthiness of a user on an online platform is illustrated, in accordance with an embodiment of the present subject matter. The system 101 may generate a user unique print composed by at least personal data, social networking data, psychometric data, metadata and geolocation data, wherein the social networking data is associated to a plurality of interactions of the user on one or more social networking platforms, and wherein the psychometric data is associated to user's actions on a computer-based system. The psychometric behaviour attributes may be generated based on the user's actions comprising input data provided by the user, user's way of providing the input data, user's sign-up process, user's approach for a loan, and the like. The system 101 may further analyse the personal data, the social networking data, the psychometric data, the user's computer-based system's metadata and the geolocation data in order to determine the user's personal attributes, socio-behaviour attributes, psychometric attributes and socio-economic attributes. The system 101 may further monitor interactions and behaviour of the user on one or more social media platforms in order to determine the socio-behaviour attributes for the user. The system 101 may further compare the metadata, provided by the user within the platform, with predefined reference information in order to generate psychometric and socio-economic attributes for the user. Further, the system 101 may generate the user-specific print based on a combination of the user's personal attributes, the socio-behaviour attributes, the psychometric attributes and the socio-economic attributes. The system 101 may further compare the user-specific print with a plurality of predefined patterns pre-trained by a machine learning model in order to match the user-specific print with at least one of the plurality of predefined patterns. The system 101 may further compute a score for the user based upon the matching of the user-specific print with the at least one of the plurality of predefined patterns, wherein the score indicates a credit worthiness of the user.

Although the present subject matter is explained considering that the system 101 is implemented on a server, it may be understood that the system 101 may also be implemented in a variety of computing systems, such as a laptop computer, a desktop computer, a notebook, a workstation, a mainframe computer and the like. It will be understood that the system 101 may be accessed by multiple users through one or more user devices 102-1, 102-2 . . . 102-N, collectively referred to as user 102 hereinafter, or applications residing on the user devices 102. Examples of the user devices 102 may include, but are not limited to, a portable computer, a personal digital assistant, a handheld device, and a workstation. The user devices 102 are communicatively coupled to the system 101 through the network 103.

In one implementation, the network 103 may be a wireless network, a wired network or a combination thereof. The network 103 can be implemented as one of the different types of networks, such as intranet, local area network (LAN), wide area network (WAN), the internet, and the like. The network 103 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 103 may include a variety of network devices, including routers, bridges, servers, computing devices, storage devices, and the like.

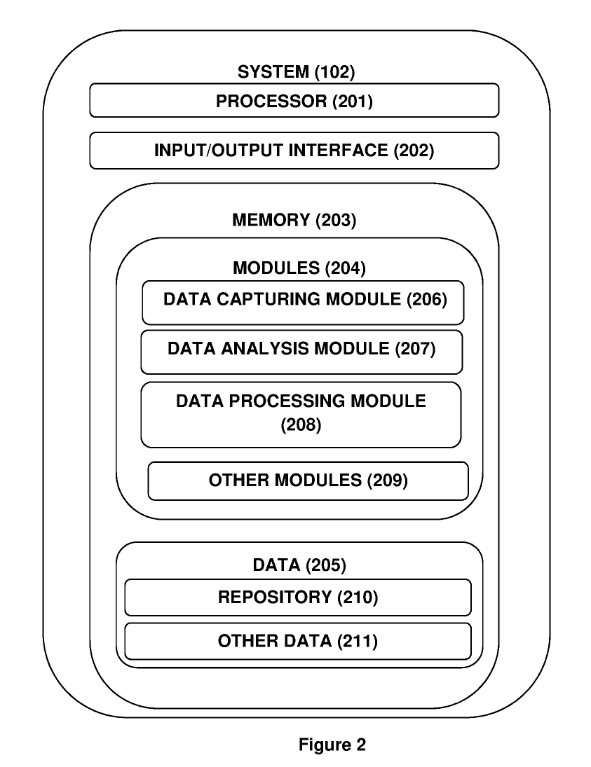

Referring now to FIG. 2, the system 101 is illustrated in accordance with an embodiment of the present subject matter. In one embodiment, the system 101 may include at least one processor 201, an input/output (I/O) interface 202, and a memory 203. The at least one processor 201 may be implemented as one or more microprocessors, microcomputers, microcontrollers, digital signal processors, central processing units, state machines, logic circuitries, and/or any devices that manipulate signals based on operational instructions. Among other capabilities, the at least one processor 201 is configured to fetch and execute computer-readable instructions stored in the memory 203.

The I/O interface 202 may include a variety of software and hardware interfaces, for example, a web interface, a graphical user interface, and the like. The I/O interface 202 may allow the system 101 to interact with a user directly or through the client devices. Further, the I/O interface 202 may enable the system 101 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting a number of devices to one another or to another server.

The memory 203 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 203 may include memory 204 and data 205.

The modules 204 include routines, programs, objects, components, data structures, etc., which perform particular tasks or implement particular abstract data types. In one implementation, the modules 204 may include a data capturing module 206, a data analysis module 207, a data processing module 208, and other modules 209. The other modules 209 may include programs or coded instructions that supplement applications and functions of the system 101.

The data 205, amongst other things, comprises a repository 210 for storing data processed, received, and generated by one or more of the modules 204. The data 205 may also include a personal information data, a social networking data, a metadata, and other data 211. The other data 211 may include data generated as a result of the execution of one or more modules in the other module.

In one implementation, at first, a user may use the user device 102 to access the system 101 via the I/O interface 202. The user may register him/her using the I/O interface 202 in order to enable the online platform to initiate the determination of user's credit worthiness. The system 101 may capture data and analyse the data to generate user's personal attributes, socio-behaviour attributes, psychometric attributes and socio-economic attributes. In order to categorize the user, the system 101, at first, may capture set of data comprising user's personal data, social networking data, geolocation data and the metadata. The said set of data are provided by the user via the user device 102. Specifically, in the present implementation, the categorization of the user is based on the attributes comprising user's personal attributes, socio-behaviour attributes, psychometric attributes and socio-economic attributes. The attributes may be used later by the system 101 to generate user specific print and compare the user specific print with predefined patterns trained by a machine learning model and thereby computer a score for the user to determine the user's credit worthiness. The detail working of the system 101 along with the modules 204 of the system 101 is further explained as below.

Data Capturing Module

In one implementation, the user while registering on the online platform may enter personal data which is captured by the data capturing module 206. The personal data may include personal information of the user comprising name, date of birth, primary address of residence, one or more secondary address of residence, educational qualification, professional history, hobbies, phone logs. Additional data relative to the user's business may further comprise business details of the user like the type of business, the place of business, business structure, size of business.

Further, the data capturing module 206 may capture social networking data, geolocation data and psychometric data associated with the user. In an embodiment, the social networking data is associated to a plurality of interactions of the user on one or more social networking platforms. In an embodiment, the user may authorize the system 101 to capture, via the data capturing module 206, the social networking data based on a plurality of interactions of the respective user on one or more social networking platforms. The plurality of interactions of the user may comprise likes, shares, posts, tweets, comments, publications, and interests of the user on one or more social networking platforms. In an implementation, the data capturing 206 module may capture user information and interactions of the user with other users on social networking platforms. The data capturing module 206 may extract information comprising people followed by the user, one or more pages liked by the user, user's publications and the publication user relays, post, status updates, comments, tweets made by the user and shared by the user, image or video shared by the user.

In one embodiment, the psychometric data is associated to user's actions on a computer-based system(s). Therefore, the psychometric behaviour attributes may be generated based on the user's actions comprising input data provided by the user, user's way of providing the input data, user's sign-up process, user's approach for a loan request, and the like. The geolocation data of the user may provide primary significance for assuring whether the user lives at the place where he has provided the place of residence or the place of business. Further, the provision of the geolocation data associated to the user may further be used to quantify the level of confidence, the system may rely on the user by comparing the said geolocation data with geolocation information provided by the user in his/her social media content on the social media platforms.

In an implementation, the data capturing module 206 may extract the reference data provided by the regional governmental/Non-governmental organizations. The data capturing module 206 may refer to those reference data from the region where the user's business is located. For example, if a user's business is in a province “P”, the income of the user is “N” and his business sector is agriculture, then the data capturing 206 module may capture these attributes with what the government has recently published and assert a too large delta between the user's business and the reference data as a potential risk. The data capturing module 206 may further capture the analysis of the unemployment rate of the location as an additional attribute to consider in risk evaluation for categorization.

Data Analysing Module

In one implementation, the data analysing module 207 may access the captured data for analysing the user based on his/her user profile. Examples of social networking platforms may include social networking websites, feedback/review collection websites, and blogs. A list of social networking platforms may be provided by the user at the time of registration and such list of social networking platforms may be stored in the data 205 of the system 101. Further, the user may also permit the data analysis module for mining the social networking data from websites named in the list of social networking platforms.

In an implementation, the data analysis module 207 may monitor, analyse and compare the aforementioned data captured by the data capturing module 206. The data capturing module may execute Natural Language Processing, Text Mining and any other content analysis techniques to analyse the content of textual input comprising posts, comments, tweets, shared data, shared links and the like. Furthermore, in the text mining, the data analysis module 207 may standardize some common knowledge terms such as N-Y, NY or New York are to be considered same. The data analysis module may further eliminate step words comprising the, and, in, of, by etc.

In an implementation, the data analysis module 207 may further group and count each term occurred in the social networking data. The data analysis module 207 may further count how many times a term appears in the text or how many times sequences of 2 consecutive words appear. For example, counting technique respectively called: “Bags of words” and “n-grams”—to be used as n equal to 2 wherein n is the number of terms. The number of times a term occurs in a document may be referred as its term frequency (TF). The weight of a term that occurs in a document is proportional to the term frequency. The nature of term is dispersed/diffused in a document is commonly measured by the equation called “Inverse Document Frequency” (IDF). The data analysis module 207 may further use the IDF factor to reduce the weight of terms that occur with a high frequency in the social networking data and increase the weight of terms that occur rarely. The data analysing module 207 may use both the methods and calculate the product of the TF and IDF. The product of the two may generate a measure to be referred as TFIDF which gives a very good representation of the importance of a term within the document.

The TF, IDF and their TFIDF may further be calculated by using the Formula 1, Formula 2 and Formula 3 represented below. tf(t,d) is the number of times that term t occurs in document d.

$$\begin{matrix}tf ( t , d ) = 0.5 + 0.5 \cdot \frac{{f}_{t , d}}{max \{ {f}_{{t}^{′} d} \text{:} {t}^{′} ∈ d \}} & Formula 1 \\ idf ( t , D ) = log \frac{N}{\vert \{ d ∈ D \text{:} t ∈ d \} \vert} & Formula 2\end{matrix}$$

N: total; number of documents in the corpus N=|D|
   |{d ∈ D:t ∈ d}|: number of documents where the term l appears (i.e., tf(t,d)≠0). If the term is not in the corpus, this will lead to a division-by-zero. It is therefore common to adjust the denominator to 1|{d ∈ D:l ∈ d}|.

tfidf(t, d, D)=tf(t, d)·idf(t, D) Formula 3:

In an implementation, the data analysis module 207 may further normalize the term frequency with respect to the social networking data length and may apply methods of “features selection” that may allow accelerating the analysis process by selecting only the more relevant words (features) and start the analysis only on that subset. The data analyzing module 207 may select the features, for example, by imposing minimum and maximum thresholds of terms counts, or by measuring the information gain of each terms to rank the terms by importance (removing the low gain terms from the list).

In an embodiment, the data analysis module 207 may analyse the user's socio-behaviour i.e. the interactions of the user with other users, the content that the user shares, or the other actions the user performs on the platform such as commenting, liking a specific post, a specific page or a specific tweet, and the like. The data analysis module 207 may further integrate the user and the user's network to the system's historical network of all its users to see if any connection can be made or found already existing in the system's historical data. The data analysis module 207 may further measure the type and strength of the interactions and strives to define attributes like the user's influence over his friends, or other measurement on the user interactions profile. In the case, if data analysing module 207 extracts some connections between the user and previous users, the data analysing module 207 may also look at the behaviour of those previous users regarding their repayments within the platform.

In an embodiment, the data analysis module 207 may enable search of global and local patterns in the network and may further integrate to a 2 Dimension Directed Adjacency matrix of the historical users the user and the user's relations, if not already present. From the matrix, the data analysing module 207 may measure attributes like the Global distribution, clusters of users, the transitivity. The data analysing module 207 may detect potential cycles, and define the geodesic of the user i.e. the shortest path between two users. The data analysis module 207 may further compute the numerical quantification of the user's position in the plurality of social network platforms by aggregating the results of the previous step for socio-behaviour and adding additional measurements like calculating the degree of the user i.e. the number of connections the user, user's centrality; connectedness; Closeness/decay; betweeness; influence/Eigenvector; transitivity; support; Path length to other users—with good and bad records; his average path length, the diameter of the user's graph, clustering with other users via the interaction to define how strong is relationship. The data analysing module 207 may finally integrate the user's list of likes into a general “Likes & Interests” matrix where all the social networking data of the user's likes are exhaustively listed and compared to the likes of historical users' base. The matrix may be analysed later with other attributes to search for patterns. In an embodiment, with the personal data and the social networking data, the data analysing module 207 is capable to define a user's digital attributes which may also allow the data analysing module 207 to analyse and process the user personal attributes and socio-behaviour attributes.

In an exemplary embodiment, the data analysis module 207 may further compare the user profile accessed from a plurality of social media platforms with the regular profile. The comparison is made based on multiple parameters of social networking data, date of profile creation, frequency of interaction with other connections, volume of data shared via the profile in order to determine for fraud detection. The fraud detection may be obtained based on the differences observed between the user profile and the regular profile. If there exist any ambiguity, then the data analyzing module 207 may highlight the user with a flag alert.

In an embodiment, the data analyzing module 207 may also correlate the user's business information provided by the user within the platform with the reference data provided by the regional governmental organization or Non-governmental organization. The reference data may be selected from that region where the user's place of business is situated. The correlation may enable the data analysing module 207 to generate a socio-economic attributes facilitating to analyse the credit worthiness of the user based on the user's business location and the status of the location relevant to user's business.

In an embodiment, the user's psychometric behaviour comprising psychometric data associated to user actions on one or more computer based system 101 may also be added to the matrix where all the other user's data may be incorporated. The examples of the user's actions may comprise user's input data, user's way of providing the input data, user's sign-up process, user's approach for a loan request, and the like. The matrix may be used to run a set of predictive algorithms and may be used to analyse a series of patterns. The data analysis module 207 may be used to address the risk of default relative to the information the system 101 has from the user. This psychometric analysis may provide psychometric behaviour attributes. The psychometric behaviour attributes may comprise time spent by the user to complete/fill each fields of his loan application, whether the delta between the number of characters in his description and the number of times he pressed a key on his user device 102 is important. If yes, then it can be because the user performed a copy/paste of the content or because he put a lot of effort, how does the user choose the loan amount he would request to borrower—either straight to the maximum or more precise approach. The data analysing module 207 may also analyse data from the user device 102, like user device logs to analyse the general use of the phone and other meta-data like the geolocation data.

In an embodiment, the attributes generated (user's personal attributes, socio-behaviour attributes, psychometric attributes and socio-economic attributes) may incorporate data sets in one or more matrices. The attributes are generated by the processor 201 of the system 101 by processing the personal data, socio-behaviour data, psychometric data and geolocation data with the reference data and further categorising each data set and storing each data set in a pre-defined required format. The format may be in the form of matrices wherein each matrix element may reflect data points associated with the above personal data, socio-behaviour data, psychometric data and reference data. The user's personal attributes may comprise generation category or his age, progress of user's business, pre-owned loans of the user, monetary status, relationship status and the like. The socio-behaviour attributes may comprise nature of interaction on social media platforms, nature of the contents the user likes, one or more comment sets, the nature and content of publications made by the user, user's log-in/out time lines, shared media and contents and the like. The psychometric attributes may comprise user's actions on the computer-based system. The user's actions on the computer-based system may comprise data points associated with the user's input, user's way of providing data, user's sign-up process, user's approach for a loan request and some of the computer based system's metadata and geolocation. The socio-economic attributes may further comprise the data points generated based on the correlation of the user's business information with the reference data and further forecasting the business profile of the user.

Data Processing Module

In one embodiment, the data processing module 208 may further generate a user-specific print based on a combination of the user's personal attributes, the socio-behaviour attributes, the psychometric attributes and the socio-economic attributes. The data processing module 208 may further compare the user-specific print with a plurality of predefined patterns pre-trained by a machine learning model in order to match the user-specific print with at least one of the plurality of predefined patterns. The predefined patterns pre-trained by the machine learning model may be developed from the historical data of the system 101. The machine learning model may enable the system 101 to generate pre-defined models based on the attributes (like the socio-behaviour attributes, personal attributes, psychometric attributes and socio-economic attributes) of the other past users who have previously used the platform and their respective prints are present in the historical data. The historical data of the system 101 may comprise attributes of a plurality of other users who may have prints prior to the current user.

In an embodiment, the user specific print may be generated by processing the one or more matrices of the respective attributes and further processing the one or more matrices by implementation of a statistical model comprising traditional methods including, but not limited to, linear regression, Logistic Regression, Naive Bayes classifiers, Random Forest to more complex methods further comprising Support Vector Machines, Neural Network, Deep learning, and the like. The data processing module 208 may compare the user specific print with a plurality of patterns trained by said statistical model and thereby match the user specific print with at least one of the plurality of patterns.

An example of comparing and matching the user specific print with at least one of the predefined patterns using the Bayes theorem is provided below:

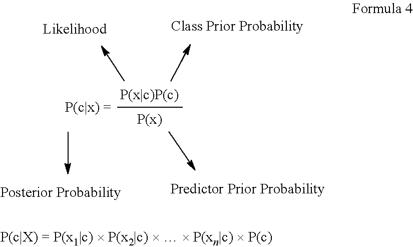

In an embodiment, the data processing module 208 may compare the user specific print with the plurality of predefined patterns obtained from a machine learning model. The machine learning model may use the one or more attributes of the historic users from the historical data and further generate the pre-defined patterns from a set of historical users' data. The data processing module 208 may compare one or more attributes associated with the user specific print generated with the one or more attributes of predefined user patterns present in the system. Each predefined pattern may have a score based on one or more attributes of the that particular predefined pattern. Each user specific print may be compared with the plurality of predefined patterns and on account of the user specific print being matched with a similar or identical predefined pattern from the plurality of predefined patterns, the data processing module 208 may assign a score range associated with the matched pre-defined pattern.

In an embodiment, after comparing the user specific print there may be a set of matched predefined patterns. The print may be associated with the one or more scores associated with the one or more matched patterns. The data processing module 208 may then assign a score to the user by enabling a computational model and to average the scores associated with the matched pre-defined patterns. The score may be in the range set of 0 to 10, or 0-100 or as defined by the system. In an embodiment, score assigned may be in percentage stating the credit worthiness of the user associated with the user in order to determine or forecast probability of the repayment of the requested loan by the said user. In an embodiment, the data processing module 208 may enable real time scoring of the user based on based on the matching of the user specific print with the historical patterns by the data processing pattern 208.

In an embodiment, the system 101 of the present disclosure may enable the user to receive a business loan without having a credit history. This system 101 may enable small and medium scale as well as newly settled business owners to conceive a loan without a credit history. The system 101 may enable the lenders to take decisions to invest or to provide loans to specific users they want to by recognizing the credit worthiness score which may be computed by the system 101.

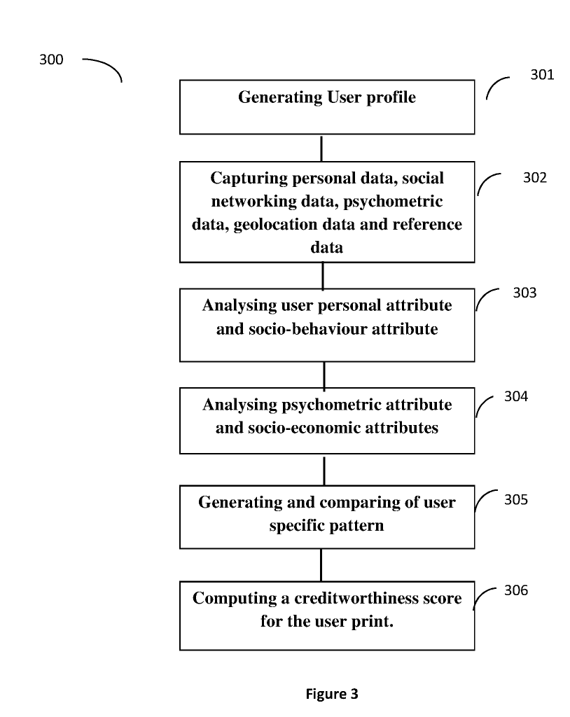

Referring now to FIG. 3, a method 300 for determining credit worthiness of a user on an online platform is shown. The method 300 may be described in the general context of computer executable instructions in accordance with an embodiment of the present subject matter. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 101.

At block 301, a user profile may be generated by the processor 201 of the system 101. In an embodiment, the user profile may be generated based upon data provided by the user via the user device 102. The user may input the user's personal data, social networking data, metadata and geolocation data. The social networking data is associated to a plurality of interactions of the user on one or more social networking platforms. The psychometric data is associated to user's actions on one or more computer based systems. In addition to other data, the user may also provide data of his profile on a plurality of social networking platforms and may give user's authorization to the system 101 so that the system may capture the social networking data of the respective user.

At block 302, the system 101 may capture the personal data, social networking data, metadata, geolocation data and metadata. The personal data may include all personal information of the user comprising name, date of birth, primary address of residence, one or more secondary address of residence, educational qualification, professional history, hobbies, phone logs. Additional data relative to the user's business can also further comprise business details of the user like the type of business, the place of business, business structure, size of business, business operation history. In addition to the personal data, the user may also provide data of his profile on a plurality of social networking platforms and may give his authorization to the system 101 so that the system 101 may capture the social networking data of the respective user. The plurality of interactions of the user on one or more social networking platforms may comprise likes, posts, tweets, shares, comments, publications, and interests of the user on one or more social networking platforms.

At block 303, the system 101 may analyse the personal data and the social networking data of the user from one or more social networking platforms and may perform Natural Language Processing, Text Mining and any other content analysis techniques to generate user's personal attributes and socio-behaviour attributes. The user's personal attributes and socio-behaviour attributes may be generated in order to provide information of the user's behaviour on online social networking sites like Facebook®, Twitter®, LinkedIn®, Instagram®, and the like. The socio-behaviour may further comprise one or more publications, tweets, videos, images shared by the user on online social networking platforms to determine the user's interests and to analyse the user's way of view towards the society. The system 101 may compare the user profile with one or more regular profiles for fraud detection purpose.

At block 304, the system 101 may further analyse the psychometric data associated to user's actions on one or more computer based systems. The examples of the user's actions may comprise input data provided by the user, user's way of providing the input data, user's sign-up process, user's approach for a loan request and the like. The system 101 may also correlate the metadata of the user with the socio-economic data which may be provided by the regional governmental organization or Non-governmental organization. The socio-economic data may be selected from that region where the user's place of business is located.

At block 305, the system 101 may further generate a user-specific print based on a combination of the user's personal attributes, the socio-behaviour attributes, the psychometric attributes and the socio-economic attributes. The system 101 may further compare the user-specific print with a plurality of predefined patterns pre-trained by a machine learning model in order to match the user-specific print with at least one of the plurality of predefined patterns. The predefined patterns pre-trained by the machine learning model may be developed from the historical data of the system 101. The machine learning model may enable the system 101 to generate pre-defined models based on the attributes of the other users present in the historical data. The historical data of the system 101 may comprise attributes of a plurality of other users who may have the prints prior to the current user. In an embodiment, the user specific print may be generated by processing the one or more matrices of the respective attributes and further processing the one or more matrices by implementation of statistical models selected from a group comprising linear regression, Logistic Regression, Naive Bayes classifiers, Random Forest to more complex methods further comprising Support Vector Machines, Neural Network, and Deep Learning.

At block 306, the system 101 may assign a score to the user based upon scores associated with the matched pre-defined patterns. The score may be in the range set of 0 to 10, or 0-100 or as defined by the system. In an embodiment, score assigned may be in percentage stating the credit worthiness of the user associated with the user for determining the probability of the repayment of the requested loan.

Although implementations for methods and systems for determining credit worthiness of a user on an online platform have been described in language specific to structural features and/or methods, it is to be understood that the appended claims are not necessarily limited to the specific features or methods described. Rather, the specific features and methods are disclosed as examples of implementations for determining credit worthiness of a user on an online platform.

1. A method for determining credit worthiness of a user, the method comprising:
capturing, by a processor 201, at least the user's personal data, social networking data, psychometric data, metadata and geolocation data, wherein the social networking data is associated to a plurality of interactions of the user on one or more social networking platforms, and wherein the psychometric data is associated to user's actions on one or more computer based system 101;
analysing, by the processor 201, the personal data, the social networking data, the psychometric data and the geolocation data in order to determine user's personal attributes, socio-behaviour attributes, psychometric attributes and socio-economic attributes for the user;
generating, by the processor 201, a user-specific print based on a combination of the user's personal attributes, the socio-behaviour attributes, the psychometric attributes and the socio-economic attributes;
comparing, by the processor 201, the user-specific print with a plurality of predefined patterns pre-trained by a machine learning model in order to match the user-specific print with at least one of the plurality of predefined patterns; and
computing, by the processor 201, a score for the user based upon the matching of the user-specific print with the at least one of the plurality of predefined patterns, wherein the score indicates a credit worthiness of the user.

2. The method of claim 1, wherein the personal data comprises name, date of birth, nationality, residential address, educational qualification, professional history, place of business, business structure and size.

3. The method of claim 1, wherein the plurality of interactions on one or more social networking platforms comprises likes, tweets, shares, posts, comments, publications, replies, images, videos, articles, interests of the user.

4. The method of claim 1, wherein the user's computer-based system metadata comprises computer-based system logs and user's geolocation.

5. The method of claim 4, wherein the user's geolocation is used to verify the user's place of business and residence and further to quantify the level of confidence the system 101 relies on the user by comparing user's content on the social media when the user incorporates a location attribute with the geolocation field present in the content on the social media.

6. The method of claim 3, wherein the social networking data is analysed based upon Social Network Analysis, Natural Language Processing, Text Mining technique and any other content analysis techniques.

7. The method of claim 1, wherein the user's profile from a plurality of social media platform is compared with the regular print with reference to parameters including social networking data, date of profile creation, frequency of interaction with other connections, volume of data shared via the profile to determine for any user a first level fraud detection by obtaining the differences between the user profile and the regular profiles.

8. The method of claim 1 further monitoring, by the processor 201, the psychometric data associated to the user's actions on a computer-based system, wherein the user's actions comprise user's input data, user's way of providing the input data, user's sign-up process, and user's approach for a loan request.

9. The method of claim 7, further processing, by the processor 201, the user's psychometric behaviour attributes using predictive algorithms to generate patterns in order to recognize risk of fraud information of the user for any second level fraud detection.

10. The method of claim 1, wherein the reference information is obtained from the governmental/non-governmental organizations for the region belonging to the user's place of business.

11. The method of claim 1, further computing, by the processor 201, a score by processing the one or more matrices incorporating data points obtained from the user's personal attributes, the socio-behaviour attributes, the psychometric behaviour attributes and the socio-economic attributes.

12. A system 101 for determining credit worthiness of a user on an online platform behaviour on an online platform, the system 101 comprising:
a processor 201; and
a memory 203 coupled with the processor 201, wherein the processor 201 is capable of executing programmed instructions stored in the memory 203 for:
capturing at least personal data, social networking data, psychometric data, metadata and geolocation data, wherein the social networking data is associated to a plurality of interactions of the user on one or more social networking platforms, and wherein the psychometric data is associated to user's actions on one or more computer based system 101;
analysing the personal data, the social networking data, the psychometric data, the metadata and the geolocation data in order to determine user's personal attributes, socio-behaviour attributes, psychometric attributes and socio-economic attributes for the user;
generating a user-specific print based on a combination of the user's personal attributes, the socio-behaviour attributes, the psychometric attributes and the socio-economic attributes;
comparing the user-specific print with a plurality of predefined patterns pre-trained by a machine learning model in order to match the user-specific print with at least one of the plurality of predefined patterns; and
computing a score for the user based upon the matching of the user-specific print with at least one of the plurality of predefined patterns, wherein the score indicates the credit worthiness of the user.

13. A non-transitory computer readable medium storing program for determining credit worthiness of a user on an online platform, the program comprising instructions for:
capturing at least personal data, social networking data, psychometric data, metadata and geolocation data, wherein the social networking data is associated to a plurality of interactions of the user on one or more social networking platforms, and wherein the psychometric data is associated to user actions on one or more computer based system;
analysing the personal data, the social networking data, the psychometric data and the geolocation data in order to determine user personal attributes, socio-behaviour attributes, psychometric attributes and socio-economic attributes for the user;
generating a user-specific print based on a combination of the user personal attributes, the socio-behaviour attributes, the psychometric attributes and the socio-economic attributes;
comparing the user-specific print with a plurality of predefined patterns pre-trained by a machine learning model in order to match the user-specific print with at least one of the plurality of predefined patterns; and
computing a score for the user based upon the matching of the user-specific print with the at least one of the plurality of predefined patterns, wherein the score indicates the credit worthiness of the user.
